(19) United States
(12) Patent Application Publication
(10) Pub. No.: US 2015/0369469 A1
(43) Pub. Date: Dec. 24, 2015

(54) In-Grade and Under-Water Light Fixture Housing Made of Ceramic Material

(71) Applicants: Ai-li LIEN, (US); Gabor VAMBERI, (US)

(72) Inventor: Gabor Vamberi, Leesburg, VA (US)

(21) Appl. No.: 14/761,440

(22) PCT Filed: Jan. 17, 2014
(86) PCT No.: PCT/US14/12068

§ 371 Date: Jul. 16, 2015

Related U.S. Application Data
(60) Provisional application No. 61/754,010, filed on Jan. 18, 2013.

(51) Int. Cl. F21V 31/00; F21V 5/04; F21V 29/507; F21S 8/02; F21V 29/74

(52) U.S. Cl. CPC F21V 31/005; F21S 8/022; F21V 29/74; F21V 29/507; F21V 5/04; F21W 2121/02

(57) ABSTRACT

A housing, particularly for a Light Emitting Diode (LED) or otherwise lamped in-grade or under-water light fixture, is made of ceramic material, such that the housing is not affected by corrosive substances commonly found in soil, masonry, and water that surrounds the installed fixture. The ceramic housing establishes a good conductor of heat and does not conduct electricity. A lens and lens frame are secured to the housing and provisions are made to assure the integrity of the overall assembly even when the light fixture is employed in damp and wet environments and/or where heavy loads can bear down on the lens, such as when the light fixture is embedded in a paved roadway and subjected to vehicular traffic rolling there over.

### CROSS REFERENCE TO RELATED APPLICATIONS

The present application claims the benefit of U.S. Provisional Patent Application Ser. No. 61/754,010 entitled “In-Grade and Under-Water Light Fixture Housing Made of Ceramic Material” filed Jan. 18, 2013. The entire content of this application is incorporated herein by reference.

### BACKGROUND OF THE INVENTION

The present invention is related generally to housings for in-grade and under-water light fixtures. In-grade light fixtures are light fixtures typically used in architectural and landscape lighting. The housing of an in-grade light fixture is installed entirely or partially below the level of the ground surface, whether earth or covered ground surfaces, such as concrete, asphalt, tile, granite, marble, stone paver, wood, and the like. In-grade light fixtures are also known as in-ground light fixtures, direct burial light fixtures and well-lights, along with other names. Under-water light fixtures are architectural light fixtures which are entirely or partially immersed in water or other water containing liquid. Examples of under-water light fixtures are swimming pool lights, fountain lights, and the like.

A common concern associated with light fixtures and other lighting apparatus wherein a significant portion of the housing of the fixture is below the ground surface, or is immersed in water, is that materials which might be present around the installed light fixture can excessively corrode, or otherwise adversely affect, the below grade or under-water portion of the fixture. These corrosive materials might be salt, acidic and alkaline materials like those that can be found in artificial fertilizers, lime, chlorine, urine, cleaning materials, solvents, and the like.

Due to these concerns, certain metals, for example aluminum alloys, typically must be protected with one or more protective coatings in order to provide adequate protection against potentially corrosive materials. Protective coatings used for this purpose include thermal-setting resinous coatings (“powder coating”), resin coatings applied through electro-deposition (“E-coating”), bituminous coatings, and the like. These coatings may or may not provide true long-term protection of the metal housing under potentially corrosive conditions. Another known approach for ascertaining long-term resistance to corrosion is the use of metals other than aluminum alloys for the construction of the fixture body, such as bronze or stainless steel, or the use of plastics, or various composite materials, which contain certain plastic resins, reinforcing fibers, and other additives.

One of the main concerns in light fixtures which utilize high-power Light Emitting Diodes (LEDs) as a light source involves the dissipation of the heat generated by the associated semiconductor processes. Dissipating this heat is essential for keeping the LED light fixture's luminous performance at desirable levels, and for the long-term maintenance of the originally intended luminous output. In order to effectively dissipate the heat, materials of reasonably high thermal conductivity, which can facilitate the successful transfer of the generated heat away from the LED light source, must be employed. The applied materials, in combination with the light fixture configuration, need to provide for a comprehensive thermal management system of the light fixture.

While most aluminum alloys have good thermal conductivity, the conductivity might be considerably downgraded by the application of the protective coating(s). Stainless steel is costly, and is not considered to have good thermal conductivity. Bronze has reasonably good thermal conductivity, but is costly, and has a tendency to react to certain materials may be contacted under certain operating conditions in various in-ground or underwater environments. Most composite materials have poor thermal conductivity. Metals such as aluminum, stainless steel and bronze conduct electricity, which might not be advantageous in certain applications of an electrical apparatus, especially under wet or moist operating conditions as unintended contact with electrical conductors may raise various safety concerns, including the potential for a person touching the fixture getting shocked or electrocuted.

Based on the above, there is seen to exist a need for in-grade and/or under-water light fixtures with improved functionality, longevity and safety. In particular, it would be advantageous for such a light fixture not to be adversely affected by salt, acid and alkaline conditions that can be expected in the water, soil, masonry or the like that surround the installed light fixture. It is also imperative that the light fixture exhibit good thermal management.

### SUMMARY OF THE INVENTION

With the above in mind, it is a primary object of this invention to provide an in-grade or under-water light or luminaire fixture that overcomes the problems and shortcomings of the prior art. More specifically, it is an object of this invention to provide a housing for in-grade and under-water light fixtures wherein the fixtures are constructed in a manner which provides for improved functionality and longevity, particularly by not being adversely affected by salt, acid and alkaline conditions that can be expected in the water, soil, masonry or the like that surround the light fixture upon installation. In accordance with the invention, the in-grade or under-water light fixture housing also facilitates good thermal conductivity and thermal dissipation and defines an exceptionally safe housing which does not conduct electricity.

These and other objects of the invention are achieved by providing a light fixture wherein the below grade or immersed portion of the light fixture comprises a housing constructed entirely or predominantly from ceramic materials which are not substantially negatively affected by salt, and/or most acidic and alkaline conditions that are typically present in the soil, masonry or water that surround the installed light fixture. Such adverse conditions can originate from marine or atmospheric salt, salt used for the de-icing of roadways and walkways, artificial fertilizers, lime, chlorine, urine, cleaning materials, solvents, and the like. The housings made of these ceramic materials in accordance with the invention will neither suffer from significant corrosion, nor otherwise disintegrate under expected operating conditions. In addition, the invention takes advantage of the thermal conducting and dissipating properties associated with ceramic materials by using these materials in the housing of in-grade or under-water light fixtures. As the ceramic materials exhibit superb thermal conducting properties, a housing constructed in accordance with the invention is ideal for LED lamping applications.

In accordance with certain embodiments of the invention, the overall light fixture includes the ceramic housing, which may include a separate electrical connection or gear compartment, a light source such as an LED or array of LEDs, an outer sleeve, a lens, a gasket seated between the lens and the housing, a lens frame secured to the housing, and a ring. The lens frame is attached to the housing, such as through the use of various mechanical fasteners, with the ring interposed between the lens frame and the housing. With this attachment, the gasket is clamped or sandwiched between the lens and the housing for at least partially sealing the interior of the housing in which the LED(s) and other components are located. The housing is preferably provided with external fins for heat dissipation purposes, as well as a cable entry port for accommodating suitable electrical wiring.

Additional objects, features and advantages of the present invention will become more readily apparent from the following detailed description of preferred embodiments when taken in conjunction with the drawings wherein like reference numerals refer to corresponding parts.

### BRIEF DESCRIPTION OF THE DRAWINGS

FIG. 1 is a cross-sectional view of a light fixture constructed in accordance with the invention.

FIG. 2 is a cross-sectional view of a light fixture, similar to that a FIG. 1, but wherein a ceramic housing of the fixture establishes a separate electrical connection and gear compartment.

FIG. 3 is an enlarged cross-sectional view of a portion of a lens frame to housing attachment according to a first embodiment of the invention.

FIG. 4 is an enlarged cross-sectional view of a portion of a lens frame to housing attachment according to a second embodiment of the invention.

FIG. 5 is an enlarged cross-sectional view of a portion of a lens frame to housing attachment according to a third embodiment of the invention.

FIG. 6 is an enlarged cross-sectional view of a portion of a lens frame to housing attachment according to a fourth embodiment of the invention.

FIG. 7 is an enlarged cross-sectional view of a portion of the light fixture of FIG. 2, with the inclusion of a vessel insert for the compartment.

### DETAILED DESCRIPTION OF THE PREFERRED EMBODIMENTS

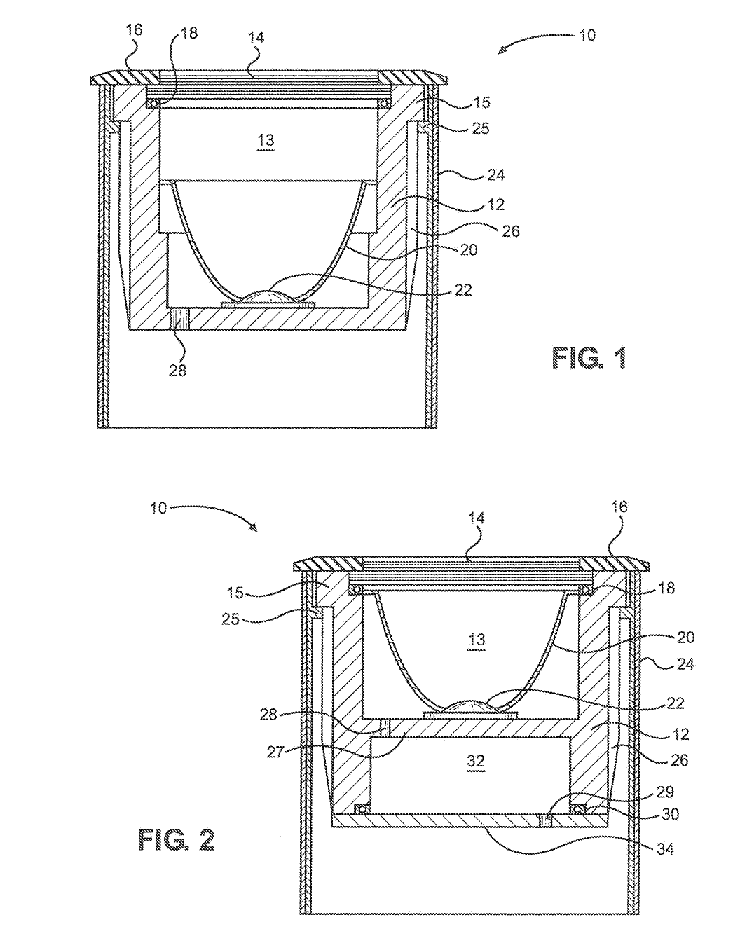

With initial reference to FIG. 1, a luminaire or light fixture in accordance with the present invention is generally indicated at 10. As will be detailed more fully below, luminaire fixture 10 employs ceramic material to provide an enclosure for a light source and other electronics, with the ceramic material assuring that the enclosure will not be affected by corrosive conditions, while exhibiting the thermal characteristics that are desirable for LED lamping. In particular, luminaire fixture 10 includes a housing 12 made of ceramic material, with housing 12 having a plurality of circumferentially spaced, upstanding heat dissipating fins 26 located on the exterior of housing 12 for heat dissipating purposes.

In the illustrated embodiment, housing 12 includes a bottom wall portion, at least one upstanding side wall and an open top portion which collectively establishes an interior optical compartment 13. The open top portion is defined by a flange 15 of housing 12. Inside interior optical compartment 13 is a light source 22, which is adapted to be electrically connected to a power source through a power cable (not shown) which can be routed into housing 12 through at least one cable entry 28. Most preferably, cable entry 28 is sized relative to the cable or, more preferably additional gasket structure is provided through the use of a waterproof cable bushing or waterproof cable gland and the like (not shown) to create a barrier around the power cable and therefore prevent the ingress of any water or other contaminants into housing 12. At this point, it should be recognized that the number and location of cable entries 28 can be varied. For instance, cable entry 28 could alternatively be located along the side wall of housing 12. Housing 12 can take various shapes, such as an overall round shape, oval-shape, square-shape, or rectangular-shape.

As indicated above, housing 12 includes heat dissipating fins 26. Fins 26 establish certain surface expanding features, which further enhance thermal dissipation. Heat dissipating fins 26 are located on the exterior surface of the side walls of housing 12 and serve as part of an overall heat sink, thereby facilitating better thermal management by increasing the rate of heat transfer to the environment away from light source 22. Fins 26 are preferably, evenly spaced apart to maximize heat dissipation and can be, but are not limited to, straight fins, straight pin fins, splayed pin fins, curved pin fins, flared fins, fluted fins, curved fins or wavy fins. In the most preferred embodiment, heat dissipating fins 26 are integrally formed as part of housing 12 so as to be made of the same ceramic material.

As illustrated, luminaire fixture 10 also includes a lens frame 16. Like housing 12, lens frame 16 can also be made of ceramic material. However, lens frame 16 can also be made from metal, plastic or composite materials. In any case, as clearly illustrated in FIG. 1, lens frame 16 extends across and is configured to be attached to flange 15 of housing 12. More specifically, lens frame 16 extends about a lens 14, which can be transparent, prismatic or translucent and made from glass or plastic materials, and is provided to secure lens 14 to housing 12. Lens 14 itself fits into a space defined by a recess (not separately labeled) established by flange 15, with a lens gasket 18 being interposed between flange 15 and lens 14. Therefore, gasket 18 is seated between flange 15 and lens frame 16, while lens frame 16 both sandwiches lens 14 with gasket 18 and also extends across an outer radial portion of flange 15. With this arrangement, lens gasket 18 establishes a waterproof seal into interior optical compartment 13 from the open top portion of housing 12 upon attachment of lens frame 16 to housing flange 15.

It is preferable that light source 22 be a solid state light source, such as, but not limited to, light-emitting diodes (LEDs), organic light-emitting diodes (OLED), or polymer light-emitting diodes (PLED). These LEDs can be miniature LEDs, mid-range LEDs, high-power LEDs (HPLEDs) or high-output LEDs (HO-LEDs). Light source 22 can be monocolor or multicolor and capable of changing color. In preferred embodiments, the solid state LEDs can be directly mounted on a circuit board in a chip-on-board (COB) assembly.

It is also preferable that interior optical compartment 13 contain optics 20 to enhance the performance of the light fixture. Optics are often a desirable feature in outdoor, in-ground and underwater lighting applications. Optics 20 can include, but are not limited to, a reflector, a multifaceted reflector, projector lens type optics or the like, and can be made of metal, clear or vacuum metalized plastic, and the like.

When fixture 10 is installed below grade (e.g., in-ground, soil or masonry installations), an insertion sleeve assembly 24 is used. Basically, insertion sleeve assembly 24 is used to establish a receptacle into which housing 12 can be inserted. For instance, in connection with an in-ground masonry installation, insertion sleeve assembly 24 establishes a concrete mask which is initially placed in a hole in the ground and then cement or concrete is poured around insertion sleeve assembly 24. For this purpose, sleeve assembly 24 can be constituted by a single layer of material or multiple layers. In one preferred from, sleeve assembly 24 is constituted by PVC tubing. In any case, once insertion sleeve assembly 24 is fixed in place, housing 12 can be inserted into and removed therefrom as needed. In the embodiment depicted, for purposes of mounting housing 12 within sleeve assembly 24, insertion sleeve assembly 24 includes an interior lip or platform 25 upon which a bottom surface of housing flange 15 is adapted to rest. In an alternative arrangement (not shown), sleeve assembly 24 is provided with an external lip for supporting housing 12. In certain preferred embodiments, lip 25 of insertion sleeve assembly 24 is provided on a separate engaging part, such as a plastic part or metal part (not shown). In situations wherein it is desired to prevent relative rotation between housing 12 and insertion sleeve assembly 24, anti-rotation structure is interposed between these components. For example, one or more projections extending from lip 25 can actually be configured to fit in the spaces formed between one or more adjacent pairs of heat dissipating fins 26. Certainly, other anti-rotational arrangements could be employed, including between flange 15 and insertion sleeve assembly 24.

FIG. 2 illustrates a modified configuration for housing 12 wherein housing 12 further includes an auxiliary, electrical compartment or a connection and gear compartment 32, which is separated or divided from optical compartment 13 by a platform 27. In some highly preferred embodiments, platform 27 is a contiguous part of ceramic housing 12 and establishes the platform on which light source 22 is mounted inside interior optical compartment 13. This configuration can be considered particularly advantageous as auxiliary compartment 32 can be employed to house an LED driver, a DC-to-DC converter, a ballast, a capacitor, a transformer, various sensors and the like or a combination thereof. As shown, a bottom cover 34 is used in conjunction with at least one compartment gasket 30, to close and seal compartment 32. In the most preferred embodiments, bottom cover 34 is in partial surface contact with housing 12, and therefore provides for further expansion of the thermal dissipating surface. In some embodiments, bottom cover 34 can be made of ceramic material, but can also be made of other suitable materials, such as metals, plastics or composite materials. However, it is preferred that bottom cover 34 is made of a material that has reasonably good thermal conductivity and thermal dissipating qualities. Bottom cover 34 also includes a cable hole or entry 29 adapted to receive a power cable (not shown) in a sealed manner, preferably through the use of a waterproof cable bushing or waterproof cable gland and the like (not shown) which prevents the ingress of foreign material and water into electrical compartment 32 of housing 12.

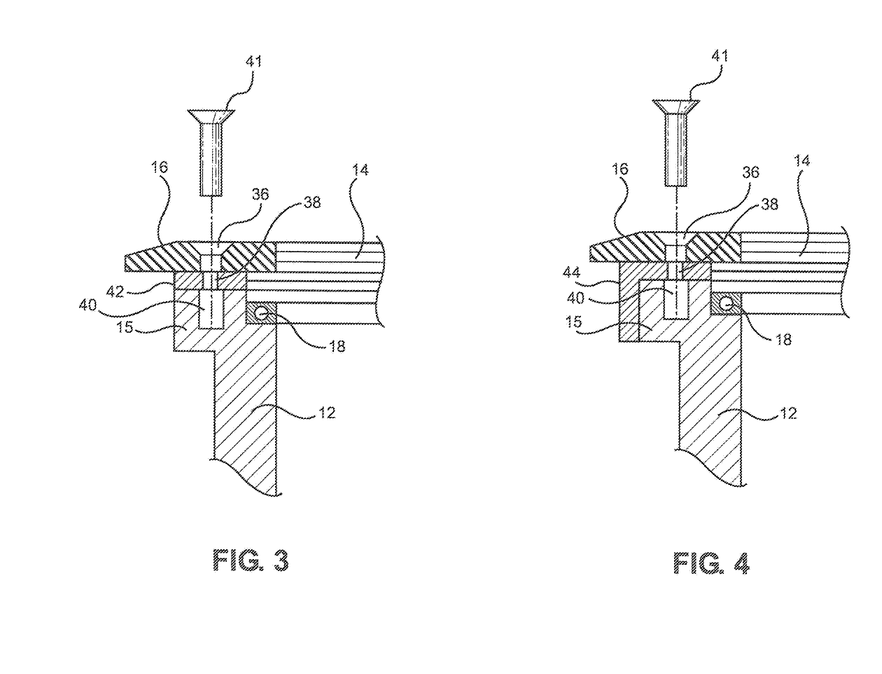

In some advantageous embodiments, bottom cover 34 is fastened to ceramic housing 12 with corrosion resistant fasteners (not shown), such as stainless steel screws or the like, with the fasteners being screwed or otherwise anchored to housing 12 through a plurality of internally threaded sleeves, bosses, or the like which are rigidly attached to housing 12 by mechanical and/or adhesive means or integrally formed with the ceramic housing. Most preferably, the internally threaded sleeves or bosses are separately formed of metal, plastic, composite material or a combination thereof and attached to housing 12 by mechanical or adhesive means such as resinous bonding or resinous encapsulating. In a most advantageous embodiment, bottom cover 34 is fastened to ceramic housing 12 by corrosion resistant fasteners, such as stainless steel screws or the like, and the fasteners are screwed or otherwise anchored to housing 12 through a flat ring that resembles a large washer in a manner analogous to that set forth below with reference to FIGS. 3-6.

As indicated above, it is important in connection with the present invention that housing 12 is made substantially entirely of ceramic material and has a high ingress protection rating for below grade or immersion applications. At the very least, more than 80% of housing 12 is composed of ceramic material and the material is substantially homogeneous in composition and physical properties throughout its volume. Examples of ceramic materials that can be used in accordance with the present invention include aluminum oxide, aluminum nitride, silicon nitride, beryllium oxide, and other advanced ceramic materials with reasonably good thermal conductivity. Making housing 12 of these ceramic materials enables housing 12 not to be negatively affected by salt, as well as most acidic and alkaline conditions which can be expected in the soil, masonry, water or the like that surrounds light fixture 10 when employed in these particular environments. For instance, in the environments in which the invention pertains, adverse conditions can originate from various sources, including marine or atmospheric salt, salt used for the de-icing of roadways and walkways, artificial fertilizers, lime, chlorine, urine, cleaning materials, solvents, and the like. Because the ceramic material is unaffected by corrosive conditions for operational purposes, the surface of housing 12 does not need to be coated. Therefore, no coating materials need to be applied, which might potentially hamper thermal dissipation. In addition, the ceramic material advantageously will not conduct electricity, but instead provides an electrical isolating and insulating function so as to exhibit safety related benefits.

It is also important to note that these types of ceramic materials possess good thermal conductivity. Heat can be detrimental to the performance and longevity of a solid state light fixture and the various components thereof. Excessive heat is especially detrimental to the luminous performance and longevity of LEDs and some of the electronic components which are used in conjunction with them. Therefore, the ceramic housing serves as a beneficial component of the light fixture's thermal management system. Under optimal circumstances, a significant portion of the ceramic housing is utilized as a heat-sink. Good surface contact between the heat generating components and the ceramic light fixture housing will aid in the transferring of the heat away from the heat generating components.

Certainly, there exist potential disadvantages to using ceramics in light fixture housings, such as related disadvantages like hard-to-maintain tolerances and poor resistance to impact. However, the invention addresses potential drawbacks with additional structure allowing for secure attachments and even extreme forces to be exerted on lens 14, lens frame 16 and housing 12 of light fixture 10. In fact, one main use of the light fixture constructed in accordance with the invention concerns installing the light fixture in a paved walkway or roadway where it can be exposed to pedestrian foot traffic or where vehicular traffic can roll over the installed light fixture. At least in such situations, certain additional features of the overall invention are employed to address this concern as will now be discussed in detail with reference to FIGS. 3-6.

FIG. 3 shows in more detail a lens frame attachment embodiment where a flat ring 42 is utilized for the attachment of lens frame 16. In a preferred embodiment, lens frame 16 is fastened to housing flange 15 of ceramic housing 12 by a plurality of corrosion resistant fasteners 41, such as stainless steel screws or the like, and fasteners 41 are screwed or otherwise indirectly anchored to housing 12 through ring 42 that resembles a large washer. Ring 42 is flat and has a plurality of internally threaded holes 38 that are perpendicular to the ring's flat surface and establish a means for mechanically attaching lens frame 16, thereby avoiding any necessity to directly attach lens frame 16 to housing 12. To this end, flat ring 42 can be made of metal, plastic or composite materials.

As illustrated, the structure of each of lens 14, gasket 18 and lens frame 16 need not change to accommodate ring 42. Instead, FIG. 3 simply illustrates a reduction in the height of flange 15 to account for a height of ring 42. As shown, flat ring 42 has radial dimensions corresponding to that of flange 15 such that ring 42 has a major diameter corresponding to an outside diameter of housing flange 15, as well as a minor diameter exposed to interior optical compartment 13. Although flat ring 42 can be simply positioned and then sandwiched between lens frame 16 and flange 15, ring 42 is preferably mechanically attached, fused or adhesively attached with room temperature vulcanizing (RTV) material, such as silicone rubber or the like, to housing flange 15 in a structurally sound manner. Lens frame 16 is fastened to ring 42 by corrosion resistant mechanical fasteners such as stainless steel screws and the like. In embodiments where both lens frame 16 and ring 42 are made of plastic material, the fastening may be achieved by means of ultrasonic welding.

For embodiments where threaded fasteners are used, internally threaded holes 38 on flat ring 42 align with a formed or machined recess or recesses 40 in housing flange 15 that are perpendicular to the flat ring engaging edge of housing flange 15. During assembly, after properly positioning gasket 18 and lens 14, a plurality of through holes 36 on lens frame 16 are then aligned with the internally threaded holes 38 on flat ring 42 and recesses 40 of housing flange 15. Fasteners 41 are inserted into the aligned holes 36, 38 and 40. Again, when fasteners 41 constitute threaded fasteners, internally threaded holes 38 engage threads on fasteners 41. The portion of the threaded shaft of fasteners 41 that projects past the thickness of flat ring 42 protrudes into recess 40 of housing flange 15. Therefore, with this preferred construction, there is no threaded connection directly with the ceramic housing 12 while, when fully tightened to ring 42, fasteners 41 secure lens frame 16 to housing flange 15. In embodiments where housing 12 is not round in plan view, but rather oval or some polygonal shape, the shape and dimensions of flat ring 42 preferably matches the shape and approximate major and minor dimensions of the edge of housing flange 15 which engages flat ring 42.

FIG. 4 depicts another embodiment of the present invention wherein a ring 44 includes a returned lip to provide for additional surface contact with housing flange 15. The returned lip is substantially perpendicular to the flat surface of flat ring 44, and is radially located along a minor, a major, or both the minor and the major circumference of flat ring 44. With this arrangement, the returned lip(s) engages housing flange 15 at its exterior, interior, or both exterior and the interior side portions, each of which is substantially perpendicular to the flat ring engaging edge of housing flange 15. The returned lip or edge of flat ring 44 is configured with load bearing and/or load transferring qualities to allow for heavy weights to bear down on lens 14, lens frame 16 and housing 12 of light fixture 10. Again, lens frame 16 is fastened to ring 42 by corrosion resistant mechanical fasteners such as stainless steel screws and the like. In embodiments where both lens frame 16 and ring 44 are made of plastic material, the fastening may be achieved by means of ultrasonic welding.

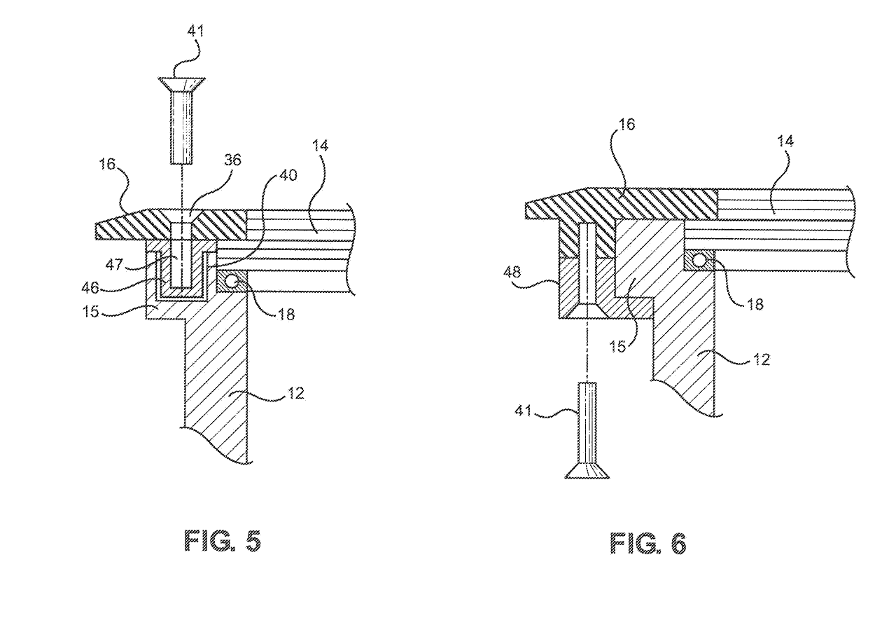

FIG. 5 shows an alternative embodiment where a flat ring 46 comprises bosses at various circumferentially spaced fastener engaging locations. The shafts of the bosses are perpendicular to the flat part of flat ring 46. In assembly, these bosses protrude into one or more recesses 40 provided on the flat ring engaging edge of housing flange 15. In this embodiment, the shafts of fasteners 41 are partially, or preferably entirely, retained in an internally threaded hole 47 of each boss of a respective ring 46, which is parallel or concentric to the axis of each boss. The bosses substantially increase the surface and the number of threads that engage fasteners 41. As should be readily apparent based on this description, flat ring 46 having the bosses will also exhibit load bearing and/or load transferring qualities which will allow for heavy weights to bear down on lens 14, lens frame 16 and housing 12 of light fixture 10.

Referring now to FIG. 6, there is shown another advantageous embodiment that includes a clamping ring 48. Clamping ring 48 engages both a bottom surface and an exterior sidewall of flange 15 of ceramic housing 12, e.g., the surface opposite the flat ring engaging edge of housing 12 and an exterior sidewall of flange 15. Clamping ring 48 can be made of metal, plastic or other suitable material and may or may not be adhesively or otherwise fixedly attached to ceramic housing 12. In accordance with this embodiment, lens frame 16 is fastened to clamping ring 48 with housing flange 15 retained between lens frame 16 and clamping ring 48. As with the other embodiments discussed above, the fastening of lens frame 16 and clamping ring 48 can be achieved by corrosion resistant mechanical fasteners 41, such as stainless steel screws, rivets or the like, or can be achieved through the use of adhesives. In embodiments where both lens frame 16 and clamping ring 48 are made of plastic material, the fastening can be achieved by ultrasonic welding. In embodiments where both lens frame 16 and clamping ring 48 are made of metal, such as stainless steel, the fastening can be achieved by metal welding.

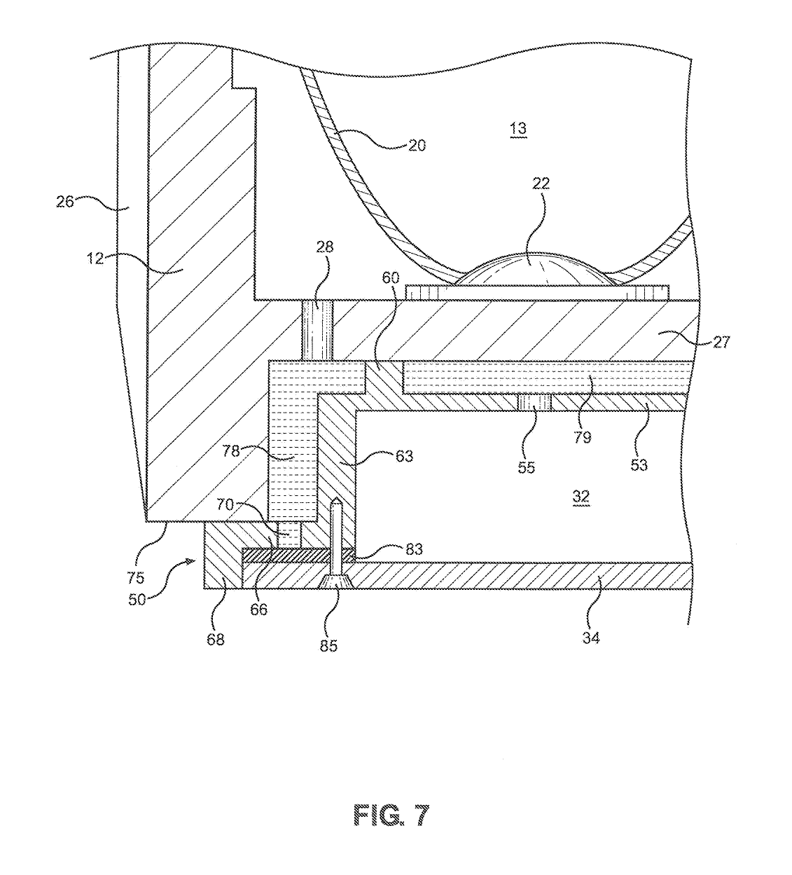

As indicated above, bottom cover 34 can be fastened to ceramic housing 12 in various different ways, including with corrosion resistant fasteners. However, as with the case of attaching lens frame 16 to housing 12, it can be desirable to provide an indirect attachment. FIG. 7 shows a portion of housing 12 and illustrates an embodiment wherein a plastic, preferably injection molded vessel or cup 50 is employed in attaching bottom cover 34. As shown, vessel 50 is inserted into compartment 32, with vessel including a base 53 having a wire routing opening 55. Base 53 is spaced from platform 27 by various spaced standoffs or feet elements 60 which extend from base 53 at spaced locations and abut platform 27. Base 53 also includes a sidewall 63 which can be uniformly thick or have a main thickness generally corresponding to base 53 in combination with various circumferentially spaced, thicker regions which define bosses (as shown). Extending outwardly from sidewall 63 is a radial flange 66 which leads to a return edge or rim portion 68 of vessel 50.

When vessel 50 is concentrically positioned within compartment 32, radial flange 66 abuts a terminal wall 75 of housing 12, with base 53 being spaced from platform 27 by standoffs 60, while sidewall 63 is also spaced from housing 12. With this arrangement a cavity, including a first cavity portion 78 along sidewall 63 and a second cavity portion 79 along base 53, is established between vessel 50 and housing 12. Radial flange 66 is formed with an injection port 70 which leads into each of the first and second, fluidly connected cavity portions 78 and 79. Another port (not shown) is also provided at a spaced location from injection port 70, such as on an opposing portion of radial flange 66. Once vessel 50 is situated in this manner and the necessary cable wires are routed from light source 22 through cable entry 28 and routing opening 55, specifically with the use of silicone or other types of sealing plugs (not shown), housing 12 can be inverted and vessel 50 clamped or otherwise fixedly retained within compartment 32. Thereafter, a potting or other encapsulating resin can be injected into injection port 70 to fill first and second cavity portions 78 and 79. The port on the opposing portion of radial flange 66 can either be used to also inject resin or, advantageously, employed as both a vent hole and also as a riser to provide a visual indication of when the injection operation is complete. In any case, the injected resin will evenly fill the entire cavity and permanently bond vessel 50 to housing 12. The resin also prevents water and other contaminants from entering optical compartment 13 through compartment 32. In particular, an enhanced condensation barrier is established. Preferably the resin is a catalyzed, setting-type resin such as polyurethane, polyester, and the like, which hardens at a relatively fast rate. Alternative potting materials might be un-catalyzed resins, low viscosity silicone sealant, and the like.

After the resin sets, a gasket 83 is positioned along radial flange 66 so as to extend over ports 70. Thereafter, bottom cover 34 is placed upon gasket 83 within the confines of rim portion 68. Then, corrosion resistant fasteners 85, such as stainless steel screws and the like, are employed to removably secure bottom cover 34 onto sleeve 50 and, indirectly, to housing 12. Although not shown in this figure, bottom cover 34 includes cable hole 29 for the directing a mains cable into compartment 32 in the same manner discussed above. At this point, it should also be noted that other encapsulation arrangements can be employed in connection with compartment 32 such as, instead of employing vessel 50, compartment 32 could be fully filled with a resin so as to permanently retain all components and the cable within compartment 32 and avoid the need for bottom cover 34.

It should be readily apparent that the invention provides a luminaire or light fixture which employs a ceramic housing and is specifically configured for use in in-ground and under-water applications. The ceramic housing provides useful solutions to problematic aspects of in-ground and under-water applications of LED luminaires. The ceramic housing provides for good thermal management, thereby producing improved functionality, improved luminous performance, and longevity of the electronic components employed within. The ceramic housing also provides useful solution to corrosion related problems that can be expected due to corrosive substances which are often present in the water, soil, masonry or the like that surround the installed light fixture and which can adversely affecting functionality and longevity of the light fixture. The ceramic housing is electrically isolating, and therefore it provides for an exceptionally safe luminaire housing. Provisions are specifically taken to assure secure attachment of a lens frame to the housing, either directly or indirectly, and thereby preventing the ingress of potential contaminants into the housing and enabling the light fixture to be used under conditions where the above grade portion of the fixture is exposed to pedestrian or vehicular traffic. In any event, although described with reference to preferred embodiments of the invention, it should be readily understood that various changes and/or modifications can be made to the invention without departing from the spirit thereof. For instance, although the light source is shown to include its own printed circuit board (PCB), the LEDs could be mounted right on the ceramic housing so the ceramic is the PCB. In addition, other fastening arrangements for the lens frame can be employed. For example, the fastening screws for the lens frame can actually extend through bores provided in the housing frame and then screwed into the insertion sleeve assembly.

1. An luminaire fixture for in-grade or under-water applications, comprising:
a housing defining an optical compartment, said housing being made substantially entirely of ceramic material;
an LED light source mounted in the optical compartment;
a cable entry located in the housing and configured to accommodate a power cable for the LED light source;
a lens fitted in a lens frame;
a lens gasket interposed between the housing and at least one of the lens and the lens frame; and
a lens frame attachment indirectly fastening the lens frame to the housing, with the lens gasket providing a waterproof seal for the optical compartment and thermal transfer being established from the LED light source to the ceramic housing.

2. The luminaire fixture of claim 1, wherein the housing is formed with a housing flange upon which the lens frame is positioned.

3. The luminaire fixture of claim 2, further comprising a ring interposed between the lens frame and the housing flange, said lens frame being directly attached to the ring.

4. The luminaire fixture of claim 3, wherein the ring has a plurality of holes perpendicular to a flat surface of the ring and is located between the lens frame and the housing flange.

5. The luminaire fixture of claim 4, wherein a returned lip is formed at an outside circumference of the flat ring, with the returned lip extending along the housing flange.

6. The luminaire fixture of claim 4, wherein the plurality of holes are internally threaded and wherein a plurality of threaded bosses extend perpendicularly from the ring around the plurality of holes and insert into a plurality of recesses in the housing flange.

7. The luminaire fixture of claim 2 further comprising: a clamping ring clamping the housing flange to the lens frame, with the housing flange being interposed between the clamping ring and the lens frame.

8. The luminaire fixture of claim 7, wherein the clamping ring includes a returned lip formed at an outside circumference of the ring that engages a bottom surface and extends along an exterior sidewall of the housing flange.

9. The luminaire fixture of claim 2, further comprising an insertion sleeve receiving the housing, wherein the insertion sleeve includes a lip engaging a bottom surface of the housing flange.

10. (canceled)

11. The luminaire fixture of claim 2, further comprising a plurality of heat dissipating fins extending from the housing.

12. The luminaire fixture of claim 1, further comprising:
an auxiliary compartment provided in the housing;
a bottom cover;
a compartment gasket engaging the bottom cover and establishing a waterproof seal for the auxiliary compartment; and
a hole formed in the bottom cover for receiving a power cable.

13. The luminaire fixture of claim 12, further comprising: an insert vessel mounted in the auxiliary compartment, said bottom cover being indirectly secured to the housing through the insert vessel.

14. The luminaire fixture of claim 13, further comprising: at least one cavity defined between the insert vessel and the housing, said at least one cavity being at least partially filled with a resin.

15. The luminaire fixture of claim 1, wherein the fixture is configured to be embedded in a roadway and run over by vehicular traffic.

16. A method for assembling a luminaire fixture for an in-ground or under-water application, the fixture including a ceramic housing defining an optical compartment, a lens that fits into a lens frame having a lens gasket, an LED light source and a cable entry located in the housing and configured to accommodate a power cable, the method comprising:
mounting the LED light source in the optical compartment, with the LED light source being adapted to be powered by a cable routed through the cable entry and thermal transfer being established from the LED light source to the ceramic housing;
fitting the lens in the lens frame; and
mounting the lens frame indirectly to the ceramic housing, with the lens gasket forming a seal for the optical compartment.

17. The method of claim 16, further comprising: inserting the luminaire fixture into an insertion sleeve, wherein relative rotation between the insertion sleeve and the housing is prevented.

18. (canceled)

19. The method of claim 16, wherein the lens frame is mounted to the ceramic housing through a ring interposed between the lens frame and a flange of the housing, said lens frame being directly attached to the ring.

20. The method of claim 19, further comprising: forming the ring with a plurality of holes perpendicular to a flat surface of the ring, with the plurality of holes being threaded for attaching of the lens frame, and inserting a plurality of bosses which extend perpendicularly from the ring around the plurality of holes into a plurality of recesses in the housing flange, with the plurality of bosses being threaded for attaching of the lens frame.

21. (canceled)

22. The method of claim 16, further comprising: clamping a flange of the housing to the lens frame with a clamping ring.

23. The method of claim 16, further comprising:
mounting a vessel in an auxiliary compartment of the housing which is divided from the optical compartment of the housing; and
sealingly mounting a bottom cover across the auxiliary compartment.

24. The method of claim 23, further comprising: indirectly attaching the bottom cover to the housing through the vessel by injecting a resin between the vessel and the housing to bond the vessel to the housing.

25-26. (canceled)
